(19) United States
(12) Patent Application Publication
(10) Pub. No.: US 2025/0116165 A1
(43) Pub. Date: Apr. 10, 2025

(54) Buoyancy Control of Robots Downhole

(71) Applicant: Saudi Arabian Oil Company, Dhahran (SA)

(72) Inventors: Rami Jabari, Houston, TX (US); Thomas Hillman, Missouri City, TX (US); Max Deffenbaugh, Fulshear, TX (US); Abubaker Saeed, Dhahran (SA)

(21) Appl. No.: 18/911,320

(22) Filed: Oct. 10, 2024

Related U.S. Application Data
(60) Provisional application No. 63/589,187, filed on Oct. 10, 2023.

(51) Int. Cl. E21B 23/00; B63G 8/00; B63G 8/08; B63G 8/22; E21B 47/022; E21B 49/08

(52) U.S. Cl. CPC E21B 23/001; B63G 8/001; B63G 8/08; B63G 8/22; E21B 47/022; E21B 49/08; B63G 2008/004

(57) ABSTRACT

Untethered, downhole robots are described. In some cases, the downhole robots are configured to have a density within + or −20% of wellbore fluid in which it will be operating. In some cases, the downhole robots a controller capable of discerning deviation of the wellbore from vertical and, in response, control a buoyancy system to change longitudinal distribution of the weight of the robot, wherein the magnitude of the change in the longitudinal distribution of the weight suffices to reorient the robot.

### CROSS-REFERENCE TO RELATED PATENT APPLICATIONS

This application claims the benefit of U.S. Provisional Application No. 63/589,187, filed Oct. 10, 2023, the contents of which are incorporated by reference herein.

### TECHNICAL FIELD

This disclosure relates to downhole robots that are sufficiently neutrally buoyant. The robot may also leverage active buoyancy control to assist with its traversal in the well.

### BACKGROUND

Subterranean wells can be used for a variety of purposes, including producing natural resources (e.g., oil, gas, and water), stimulating the production of natural resources, storing energy and materials, and investigating geological and other physical properties of the subsurface. Subterranean wells are generally formed by drilling boreholes and casing at least a portion of the wellbore, e.g., with steel or cement. The resulting wellbores can be vertical, horizontal, or somewhere in between in (i.e., deviated wellbores).

Wellbores will generally fill with fluids that inflow from their surroundings and, in some contexts, will also contain fluids from the surface. For example, drilling fluids will commonly be injected into wellbores that are used for oil and gas production, as well as into exploration and appraisal wellbores that are drilled, at least initially, for investigating the physical properties of the subsurface.

Different downhole properties of a wellbore—including human additions to the borehole—can be relevant to the intended uses of the wellbore. Examples are given below. Because of factors like the size and depth of wellbores, it is generally challenging to measure downhole properties. Measuring downhole properties generally requires that sensors or other measurement equipment be positioned downhole in proximity to the subterranean locations that are to be measured.

By way of example, logging tools that include sensors or other measurement equipment can be tethered and lowered into a vertical wellbore. The tether connects the logging tool to surface equipment with a high strength cable that supports the weight of the logging tool. Either as the logging tool is lowered or after it reaches a subterranean location of interest, the measurement equipment can be used to measure downhole properties. Because of power requirements and the difficulty of transmitting signals through the earth, many tethered logging tools also include power and/or signal transmission cables. In some cases, mechanical support and other functionality is combined (e.g., wireline, E-line, coiled tubing).

In deviated or lateral wells, and in other cases, it can be necessary to drive a logging tool into a wellbore. Thus, in addition to measurement equipment, some logging tools also include a drive or propulsion mechanism for navigating wellbore geometries and overcoming occlusions. For example, tractors or taxis can be used to drive logging tools. In came case, the tractor or taxi remains coupled to one or more cables that can be used for retrieval, supplying power, and/or communicating with the surface. In other cases, the tractor or taxi is untethered and, in some cases, may remain downhole.

### SUMMARY

In a first implementation, an untethered, downhole robot is configured to have a density within + or −20% of wellbore fluid in which it will be operating. The downhole robot includes a generally elongate housing, at least one propulsion unit on an end of the housing on the longitudinal axis, a sensor system configured to sense structural information regarding geometry of a wellbore, determine position and orientation of the robot in the wellbore, and collect measurements characterizing the wellbore fluids and reservoir characteristics, a controller coupled to receive the sensed structural information and wellbore fluid information to control the robot's traversal within the wellbore and a memory device to log collected data locally on robot.

In some cases, the first implementation of the downhole robot can include a buoyancy system configured to change the longitudinal distribution of weight of the robot is present to aid with vertical descent and ascent when the robot is not sufficiently neutrally buoyant; and a controller capable of discerning deviation of the wellbore from vertical and, in response, control the buoyancy system to change longitudinal distribution of the weight of the robot, wherein the magnitude of the change in the longitudinal distribution of the weight suffices to reorient the robot.

In a second implementation a downhole robot includes a generally elongate housing, a buoyancy system configured to change longitudinal distribution of weight of the robot, a sensor configured to sense structural information regarding geometry of a wellbore, and a controller coupled to receive the sensed structural information and, based thereon, to discern deviation of the wellbore from vertical and, in response, control the buoyancy system to change longitudinal distribution of the weight of the robot. The magnitude of the change in the longitudinal distribution of the weight suffices to reorient the robot.

Both the first implementation or the second implementation of the downhole robot can include one or more of the following features. In response to discernment of the deviation during descent of the robot into the wellbore, the controller can be configured to control the buoyancy system to change the longitudinal distribution of the weight of the robot such that a bow of the robot is made less dense, a stern of the robot is made more dense, or densities of both the bow and the stern are changed. The controller can be configured to regulate a lateral direction of the reorientation of the robot that occurs responsive to the changed longitudinal distribution of weight. The robot can further include a steering mechanism coupled to the controller. The controller can be configured to regulate the lateral direction of the reorientation of the robot using the steering mechanism. The downhole robot can further include an orientation sensor configured to sense an orientation of the robot. The controller can be coupled to receive the sensed orientation information from the orientation sensor and to regulate the lateral direction of the reorientation based thereon. The downhole robot can include a density sensor configured to sense density of a downhole fluid surrounding the downhole robot. The controller can be further configured to control the buoyancy system to change the longitudinal distribution of the weight of the robot based on the sensed density of the downhole fluid. The buoyancy system can be a multi-chamber, internal buoyancy system that conveys liquid between chambers without communicating fluid with surroundings of the downhole robot. The buoyancy system can be configured to communicate fluid with surroundings of the downhole robot. The buoyancy system can be configured to change lateral distribution of weight of the robot. The controller can be configured to control the changes in the lateral distribution of the weight based on the sensed structural information. The downhole robot can include three or more protruding members distributed around the housing, wherein the protruding members are configured to contact an inner wall of a wellbore that is being traversed while preventing the housing from contacting the inner wall.

A first implementation of a method of navigating a wellbore with a downhole robot can be performed by a controller of the downhole robot and can include detecting, using a sensor located on the downhole robot, approach of the downhole robot to a deviation of the wellbore from vertical, and in response to the detection of the approach of the deviation, changing longitudinal distribution of weight of the downhole robot, wherein the change in the longitudinal distribution of the weight suffices reorient the downhole robot.

The first implementation of the method of navigating a wellbore can include one or more of the following features. Changing the longitudinal distribution of weight of the downhole robot can include causing a bow of the downhole robot to descend slower than a stern of the downhole robot. The method can include controlling a direction of the lateral reorientation of the downhole robot. Controlling the direction of the lateral reorientation of the downhole robot can include controlling a rudder, or a hydroplane, or a drag-generating components, or a steerable propeller, or a lateral redistribution of weight of the downhole robot. Controlling the direction of the lateral reorientation of the downhole robot can include sensing an orientation of the downhole robot and using the sensed orientation to control the direction of the lateral reorientation of the downhole robot. Changing the longitudinal distribution of weight of the downhole robot can include moving a fluid bow-ward or stern-ward between chambers housed in the robot. Changing the longitudinal distribution of weight of the downhole robot can include communicating a fluid with a surroundings of the downhole robot.

The method can include guiding the downhole robot into a sidewall of the wellbore prior to changing the longitudinal distribution of the weight of the downhole robot. The method can include comprising guiding the downhole robot into a sidewall of the wellbore prior to changing the longitudinal distribution of the weight of the downhole robot. The method can include detecting, using the sensor, approach of the downhole robot to a lateral section of the wellbore, and in response to the detection of the approach of the lateral section, generating thrust to propel the downhole robot.

The can include sensing a density of downhole fluid surrounding the downhole robot. The longitudinal distribution of weight of the downhole robot can be changed based on the sensed density.

A second implementation of a method of navigating a wellbore with an untethered autonomous downhole robot that has a density within + or −20% of wellbore fluid in which it will be operating can be performed by a controller of the downhole robot and include detecting, using a sensor located on the downhole robot, approach of the downhole robot to a deviation of the wellbore from vertical, and in response to the detection of the approach of the deviation, exclusively driving the robot with a propulsion unit, the driving including traversing a portion of the wellbore and passively reorienting the robot via guidance from geometry of the wellbore.

The second implementation of the method of navigating a wellbore can include one or more of the following features. The robot can include sensors configured to measure wellbore geometry, wellbore fluid information, reservoir characteristics and sensors configured to measure speed of the robot, depth of the robot, angular rate of the robot, attitude of the robot, and/or acceleration of the robot. The method can include determining, by the robot, position of the robot within the wellbore and determining, by the robot, orientation of the robot within the wellbore. The method can include operating a stern-mounted thruster and a bow-mounted thruster to generate thrust in both a forward direction and in a reverse direction. The method can include operating the stern-mounted thruster and the bow-mounted thruster at different speeds to roll the robot. The robot can include three or more protruding members distributed around the housing. Passively reorienting the robot can include contacting an inner wall of a wellbore with at least one of the protruding members while preventing the housing from contacting the inner wall. The method can include adjusting an orientation of the robot using the propulsion unit.

The details of one or more implementations are set forth in the accompanying drawings and the description below. Other features and advantages of the invention will be apparent from the description and drawings, and from the claims.

### DESCRIPTION OF DRAWINGS

FIG. 1 is a schematic representation of a wellbore formed below a surface of the earth.

FIG. 2 is a schematic representation of a tool designed for measuring properties downhole, namely, an untethered, autonomous downhole robot.

FIGS. 3-6 show additional details of example implementations of buoyancy systems in robots

FIGS. 7-10 schematically represent the operation of a robot in wellbore.

FIG. 11 is a flowchart of a process for navigating a robot in a wellbore.

Like reference symbols in the various drawings indicate like elements.

### DETAILED DESCRIPTION

FIG. 1 is a schematic representation of a wellbore 100 formed below a surface 105 of the earth 110. Surface 105 can either be onshore or offshore and, in general, either surface or subsea equipment will be mounted atop wellbore 100 at surface 105.

The illustrated implementation of wellbore 100 includes three portions, namely, a vertical segment 110, a lateral (or horizontal) section 115, and a heel or other deviated section 120. Vertical segment 110 extends generally vertically downward from surface 105. Lateral section 115 extends more or less laterally underground, more or less perpendicular to vertical segment 110. Deviated section 120 deviates from vertical and provides a transition between vertical segment 110 and deviated section 120. Vertical segment 110 and sections 115, 120 can be formed, e.g., by drilling a borehole and completing the borehole as desired. Wellbores can be formed with other types of sections (e.g., build, tangent, drop, hold sections) and with a variety of build rates. Although the illustrated portion of wellbore 100 is illustrated as cased, the autonomous downhole robots described herein can also be used in wellbores that are—in whole or in part—uncased.

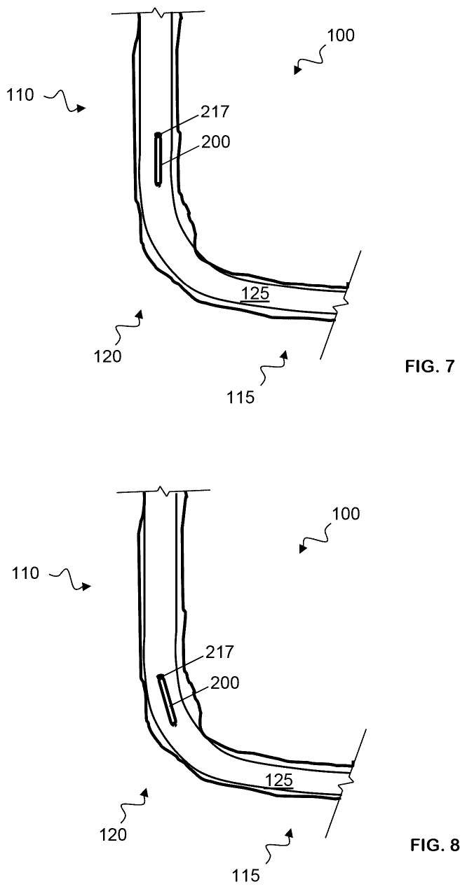

Although none of the figures in the present disclosure are drawn to scale, this is particularly egregious in FIG. 1 and in FIGS. 7-10 below. For example, wellbores for oil and gas production are typically 12 cm to 1 meter in diameter, whereas the true vertical depth of wellbores can range from tens of meters to over tens of kilometers.

In general, wellbores like wellbore 100 will be filled with downhole fluid 125. Downhole fluid 125 generally has a mixed composition and phase and may include one or more of oil, natural gas, water, drilling and completion fluids, as well as other components. The composition and phase of downhole fluid 125 will also generally change with position along the wellbore 100. For example, the water content may change with true vertical depth along vertical segment 110. As another, example, fluid 125 in lateral section 115 may phase separate and less dense gaseous phases may rise to the top of lateral section 115.

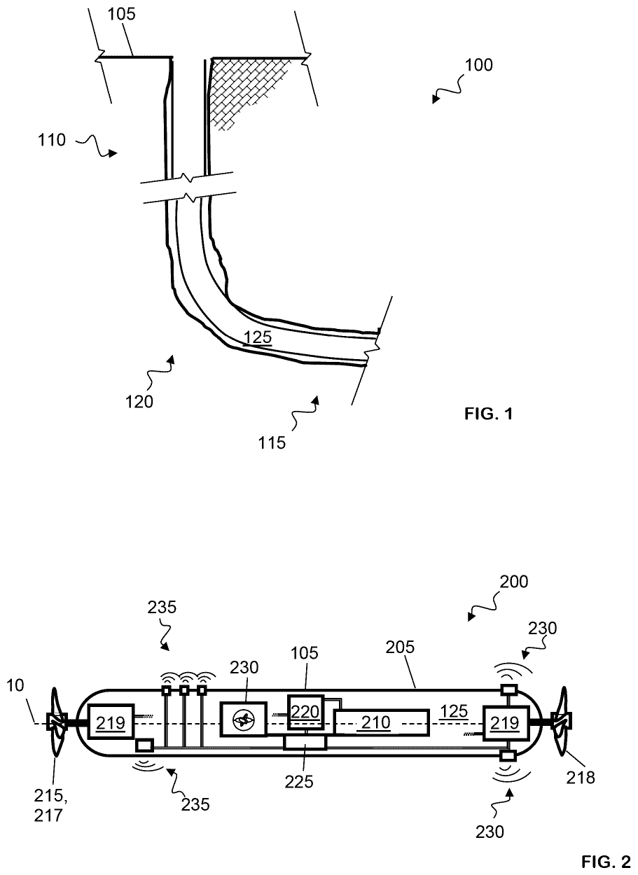

FIG. 2 is a schematic representation of a tool designed for measuring properties downhole, namely, an untethered, autonomous downhole robot 200. Robot 200 is, at least at times, self-powered, autonomous, and includes one or more sensors designed to measure downhole properties. Further, robot 200 includes both a buoyancy system 210 and a thrust-generating propulsion system 215 that can be controlled to direct robot 200 through the wellbore—including wellbores with deviated or lateral segments. In the event that the robot 200 is sufficiently neutrally buoyant (e.g., having a density that is within 20% of the wellbore fluid it is operating in), the buoyancy system 210 can be omitted.

In more detail, robot 200 includes a housing 205. Housing 205 is hermetically-sealable to protect internal components of robot 200 from downhole fluids. Housing 205 is elongate and defines a long axis 10. The dimensions of housing 205 normal to long axis 10 are kept small to avoid impeding traversal through boreholes and any casing. In implementations where housing 205 has a generally circular cross-section normal to long axis 10, the dimensions normal to long axis 10 are radial. However, housing 205 need not have a generally circular cross-section normal to long axis 10 and other lateral dimensions are possible. For example, housing 205 can have square, rectangular, oval, contoured, and other cross-sections normal to long axis 10. In some implementations, housing 205 may also include protruding fins or other members configured to reduce the contact area between housing 205 and adjacent walls, resulting in passive centralization of robot 200.

In some cases, dimensions of housing 205 normal to long axis 10 are small enough that robot 200 is insertable through surface or subsea equipment mounted atop a wellbore. For example, the diameter or other lateral dimension of housing 205 normal to long axis 10 of housing 205 can be a fraction (25% to 80%) of the smallest diameter or other lateral dimension that must be traversed in the wellbore. The smallest dimension can be, e.g., the inner diameter of production tubing, casing diameter of a cased completion without tubing, or the lateral dimension of an uncased (barefoot) borehole. In general, robot 200 is at least as long as the smallest diameter or other lateral dimension of the wellbore. For example, robot 200 can be twice as long as the smallest diameter or other lateral dimension of the wellbore. Such a combination of a relatively long and narrow robot 200 can allow robot 200 to be passively guided by the sidewalls of the wellbore in the event of contact during movement through the wellbore.

Among the components housed within housing 205 are a power source 220 and a controller 225. Power source 220 provides electrical power to components of robot 200, including the buoyancy system 210 and propulsion system 215. Because power source 220 is enclosed within housing 205, its capacity will be limited. Power source 220 is generally implemented as a battery, but can also be implemented as a fuel cell, a supercapacitor, or other source of power. As discussed further below, because of the controlled redistribution of mass by buoyancy system 210 during operation, power sources 220 with a relative high density (e.g., batteries) are generally located near the longitudinal middle of robot 200 or distributed as one or more units along the long axis of robot 200. For example, power source 220 can include two batteries coupled in parallel or series, with one fore of the longitudinal middle of robot 200 and one aft of the longitudinal middle of robot 200. In the event that the robot 200 is sufficiently neutrally buoyant (e.g., having a density that is within 20% of the wellbore fluid in which it is operating), buoyancy system 210 can be omitted.

Controller 225 is generally implemented by one or more data processors that perform operations in accordance with the logic of machine-readable instructions. The instructions can be embodied in software, in firmware, in hardware, or in combinations thereof. The operations can include navigating a wellbore, controlling logging or other information collection, and, in some cases, communicating with external equipment, including equipment on the surface.

To navigate a wellbore, controller 225 can receive information regarding a wellbore and the disposition of robot 200 within the wellbore. Further, controller 225 can control the operation of buoyancy system 210 and propulsion system 215 based on the received information.

The information relevant to navigating the wellbore can include geometric and possibly other structural information regarding the walls and other features of the wellbore, as well as information regarding fluid downhole in the wellbore. For example, robot 200 can include vibrating components 230 that generate acoustic signals for echolocating the walls of a wellbore, shift in resonant frequency and damping with fluid density and viscosity, or both. As discussed below, density measurements can be relevant to navigation when using a buoyancy system in navigating the wellbore. Robot 200 can alternatively or additionally include a variety of other sensors that provide navigational information, including imaging sensors and other electromagnetic sensors, magnetometers, collar detectors, temperature sensors, chemical sensors, and fluid property sensors. Controller 225 can receive navigational information from any of these other sensors.

The information regarding the disposition of robot 200 within the wellbore can include, e.g., the orientation/inclination and depth of robot 200 within the wellbore and the speed and direction of robot 200 within downhole fluid in the wellbore. For example, robot 200 can include a gyroscopic orientation sensor 230, an inertial measurement unit (IMU), an accelerometer, an inclinometer, an attitude and heading reference system (AHRS), or other orientation sensor. In some cases, a single sensor can provide information regarding the wellbore and information regarding the disposition of robot 200 within the wellbore. For example, collar detectors can both detect collars in the wellbore and provide information regarding the depth of robot 200 within the wellbore.

In addition to sensor(s) that sense downhole properties relevant to navigating the wellbore, robot 200 also includes one or more sensors 235 that sense downhole properties relevant to characterizing the wellbore. For example, sensors 235 can measure physical properties of downhole fluids, physical properties of components that have been introduced into the borehole (e.g., casings, joints, mud, cement, packers, other tubing), and/or the native physical properties of formations around the wellbore. Example physical properties include electrical, electromagnetic, acoustical, mechanical, compositional, fluid content, density, flow properties, and the like. In some cases, a single sensor 235 that senses properties that are relevant to navigating the wellbore and to characterizing the wellbore. Controller 225 can receive wellbore characterization information from the sensor(s) and store and/or communicate the characterization information, as needed.

As discussed above, robot 200 includes both a buoyancy system 210 and a propulsion system 215. Propulsion system 215 is configured to drive robot 200 through downhole fluid by generating thrust. Propulsion system 215 can include one or more propellers 217, 218, an impeller, or other thrust-generating component along axis 10, as well as motors 219 or another actuator. The propeller(s) 217, 218 can be protected by respective ducts. In some implementations, robot 200 also includes steering components that help determine the trajectory of robot 200 within downhole fluid. Example steering components include rudders, hydroplanes, drag-generating components, and/or mechanisms for controlling the direction of the thrust generated by the thrust-generating components. For example, propulsion system 215 may be configured to control the direction of the thrust that it generates using, e.g., a steerable or variable-pitch propeller. If more than one thrust-generating component is incorporated on the robot 200, different thrusts can be generated to induce roll, pitch, and/or yaw. In the illustrated implementation, a first propeller 217 is stern-mounted (i.e., at the rear of robot 200, at least during descent) and acts as a push propeller. A second propeller 218 is bow-mounted (i.e., at the fore of robot 200) and acts as a pull-propeller. Propellers 217, 218 may be counterrotating to minimize roll of robot 200. In some implementations, propellers 217, 218 are operated at different speeds to intentionally roll the vehicle, e.g., to align a sensor with an area to be sensed or as part of the navigation of the wellbore. In the illustrated implementation, propellers 217, 218 are coaxially mounted with long axis 10.

At least at times, power source 220—which is housed within housing 205—powers propulsion system 215. Robot 200 thus need not be tethered for propulsion system 215 to drive robot 200 through downhole fluid. However, because of the limited size of robot 200 and power source 220, it may not be possible for robot 200 to traverse large distances relying solely upon power from power source 220 to generate thrust using propulsion system 215.

Buoyancy system 210 can provide a low-power complement to propulsion system 215 in navigating a wellbore. By controlling the buoyancy of robot 200 relative to the surrounding downhole fluid, buoyancy system 210 can move robot 200 vertically.

Further, by controlling the longitudinal distribution of weight in robot 200—and hence the longitudinal distribution of buoyancy—buoyancy system 210 can also help steer robot 200 within a downhole fluid.

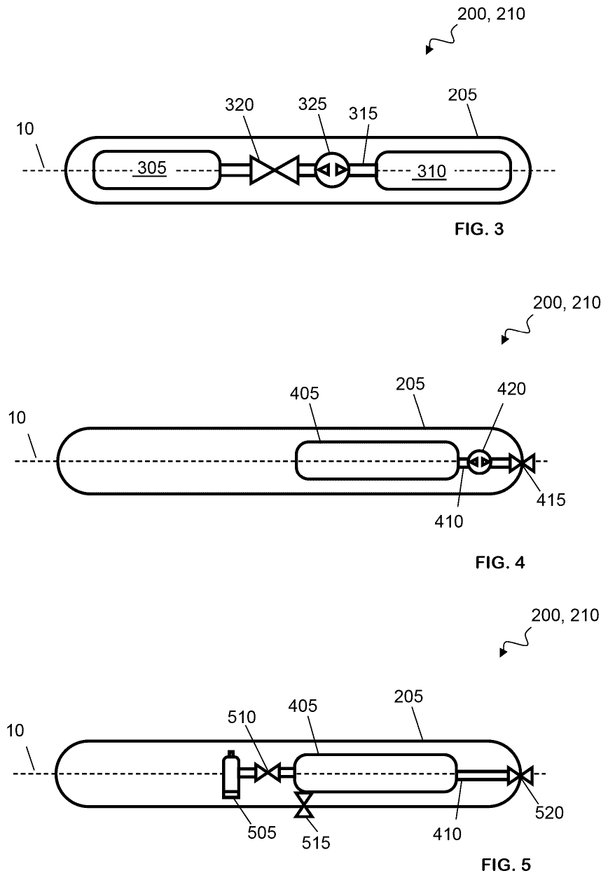

FIGS. 3-6 show additional details of example implementations of buoyancy systems 210. For didactic purposes, the example implementations are schematically illustrated in isolation without other features of robot 200. These example buoyancy systems 210 can be used in robots with thrust-generating propulsion systems and other features, such as robot 200. For example, operation of buoyancy systems 210 and the thrust-generating propulsion system 215 in robot 200 can be controlled by a controller (e.g., system controller 225) that is housed in the robot.

Further, all of the implementations of buoyancy systems 210 can also include external, releasable weights that can be dropped after descent into the wellbore.

FIG. 3 is a schematic representation of a multi-chamber, internal buoyancy system 210. The illustrated implementation includes two chambers 305, 310 that are longitudinally disposed along the length of elongate housing 205. In the illustrated implementation, chambers 305, 310 are fluidly couplable by a flow path 315 that can convey liquid between chambers 305, 310. Fluid flow path 315 is internal to robot 200 and liquid is conveyed between chambers 305, 310 without communicating with the surrounding environment. The conveyance of liquid between longitudinally disposed chambers 305, 310 changes the longitudinal distribution of weight and buoyancy in robot 200. The conveyance of liquid is not dependent on the orientation/rotation of the vehicle; the vehicle can be vertical, horizontal, or in-between.

In the illustrated implementation, fluid flow path 315 is schematically represented as a conduit with a single valve 320 and a bidrectional pump 325. When valve 320 is open, bidrectional pump 325 can provide a motive force that moves liquid between chambers 305, 310. When liquid is moved out of one of chambers 305, 310, the gaseous contents of the emptying chamber 305, 310 may expand to fill the emptying volume. When liquid is moved into one of chambers 305, 310, gaseous contents of the filling chamber 305, 310 may compress to accommodate the incoming fluid. Alternatively, chambers 305, 310 may be expandable and compressible and increase/decrease in volume when filling/emptying. For example, chambers 305, 310 may be formed from a collapsible balloon or bladder. Although fluid flow path 315 is schematically represented as including a single conduit, fluid flow path 315 may alternatively include multiple conduits, for example, one conduit to carry fluid and another to carry gas between chambers 305, 310. Further, motive force can be provided by any of a number of different pumping mechanisms. For example, one or both of chambers 305, 310 may include a piston. As another example, an external member (e.g., rollers, plates) may apply force to change the volume of expandable/compressible chambers 305, 310.

FIG. 4 is a schematic representation of a ballast tank buoyancy system 210 that can communicate fluid with the surroundings. The illustrated implementation includes a single ballast tank 405 that is disposed to change the longitudinal distribution of weight along the length of elongate housing 205. In the illustrated implementation, ballast tank 405 is disposed entirety forward of a midpoint of length of elongate housing 205. In other implementations, ballast tank 405 can be disposed rearward and/or multiple ballast tanks can be used.

In the illustrated implementation, ballast tank 405 is couplable, by a fluid flow path 410, with fluid outside of robot 200. The illustrated implementation of fluid flow path 410 includes a valve 415 and a bidirectional pump 420. When valve 415 is open, bidirectional pump 425 can provide a motive force that moves liquid between ballast tank 405 and the surroundings. Once again, the motive force for moving liquid between ballast tank 405 and the surroundings (and possibly compressing/expanding relevant ballast tanks) can be applied in other ways, acting alone or in combination. For example, a piston, a source of compressed gas, the electrolysis of water or other liquid, rollers, plates, or other mechanism can be used to provide the motive force.

In some implementations, ballast tank 405 may be compressible and increase/decrease in volume as needed. Also, in some implementation, fluid flow path 410 does not include a valve. Rather, ballast tank 405 can remain open to the surrounding environment.

FIG. 5 is a schematic representation of a ballast tank buoyancy system 210 that can communicate fluid with the surroundings. The illustrated system 200 includes a source of compressed or other (e.g., the product of electrolysis) gas 505 and a valving system of valves 510, 515, 520. The operation of valves 510, 515, 520 is coordinated by a controller (e.g., system controller 225) that is housed in the robot to control the longitudinal distribution of weight and buoyancy in robot 200.

Compressed gas source 505 provides pressurized gas at a sufficiently high pressure to provide motive force for expelling liquid from ballast tank 405. The opening and closing of valves 510, 515, 520 is coordinated during operation. For example, to expel liquid from ballast tank 405 when the long axis 10 of robot 200 is oriented vertically with valve 520 at the bottom, valves 510, 520 can both be opened while valve 515 is closed and denser liquid expelled from ballast tank 405 by the flow of less dense gas from compressed gas source 505 into ballast tank 405. While in the same orientation, valves 515, 520 can both be opened while valve 510 is closed to allow gas to escape from ballast tank 405 through valve 515 as wellbore fluid enters through valve 520.

Additional and/or more complex valving systems can be used in other implementations of robot 200 with a compressed or other gas source, including those with multiple ballast tanks and/or chambers.

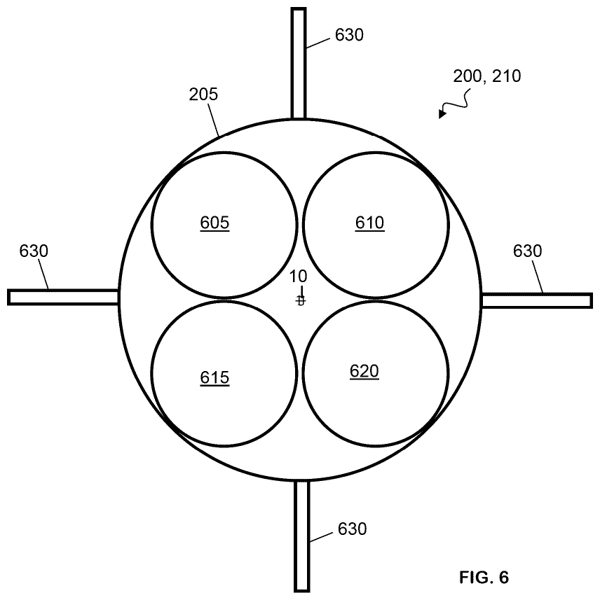

FIG. 6 is a schematic representation of aspects of a ballast tank buoyancy system 210 that, in addition to controlling the longitudinal distribution of weight and buoyancy in robot 200, can also control the radial or other lateral distribution of weight and buoyancy in robot 200.

In more detail, FIG. 6 is a schematic cross-sectional representation of a system of ballast tanks/chambers 605, 610, 615, 620 in a robot. The contents of ballast tanks/chambers 605, 610, 615, 620 can be individually controlled to control the radial or other lateral distribution of weight and buoyancy in robot 200. For example, in the illustrated orientation in which ballast tanks/chambers 605, 610 are “up” and ballast tanks/chambers 615, 620 are “down,” filling ballast tanks/chambers 605, 610 with gas while ballast tanks/chambers 615, 620 are filled with liquid will change the radial or other lateral distribution of weight and buoyancy such that the “top” side of robot 200 is lighter than the “bottom” side. Further, ballast tanks/chambers 605, 610, 615, 620 can be operated to control the longitudinal distribution of weight and buoyancy in robot 200. For example, collective operation of ballast tanks/chambers 605, 610, 615, 620 can effectively form a single ballast tank/chamber 305, 310, 405 such as described above.

Changes in the radial or other lateral distribution of weight and buoyancy can be used to provide a degree of steering to robot 200. For example, when the long axis 10 of robot 200 is oriented vertically and robot 200 is moving vertically, the lighter side of robot 200 will tend to descend slower or even rise relative to the heavier side of robot 200 and robot 200 will reorient with respect to vertical. This reorientation can be used to steer robot in a preferred direction.

To stabilize robot 200, the illustrated implementation of robot 200 includes a collection of laterally-extending fins 630. The fins 630 can help insure that a desired reorientation is achieved. For example, fins 630 can help maintain robot 200 close to vertical when descending and hinder rotation about long axis 10 during reorientation. Fins 630 can also contact inner walls of a wellbore and assist in the passive reorientation of robot 200. In particular, fins 630 reduce the area of contact between robot 200 and inner walls of a wellbore and allow robot 200 to be passively guided down the wellbore.

Ballast tanks/chambers 605, 610, 615, 620 can be part of either an internal buoyancy system 210 or part of a buoyancy system 210 that can communicate with the with the surroundings. The motive force for moving liquid can be provided by pumps, a source of compressed gas, rollers, plates, or other mechanism. Further, in some implementations, fluid can be communicated between ballast tanks/chambers 605, 610, 615, 620 themselves. For example, liquid can be moved from ballast tanks/chambers 605, 615 into ballast tanks/chambers 610, 620 to lighten the “left” side of robot 200 and add weight to the “right” side.

FIGS. 7-10 schematically represent the operation of robot 200 in wellbore 100. Once again, these FIGS. are not drawn to scale. However, for didactic purposes, the gist of the operation is represented. The operations can be controlled by a on-board controller that is internal to robot 200, such as controller 225.

During the illustrated operations, robot 200 moves from vertical segment 110, through deviated section 120, and into lateral section 115. The illustrated portions of segment 110 and sections 120, 115 are filled with downhole fluid 125. Although downhole fluid 125 is labeled with a single reference number, composition, phase, density, and/or other physical characteristics of downhole fluid 125 will generally vary with position. FIG. 7 illustrates the downward navigation of robot 200 along vertical segment 110. Although the thrust generated by propulsion system 215 can contribute to the downward navigation if desired, in general, the vertical navigation of robot 200 along vertical segment 110 will generally be driven exclusively by buoyancy system 210-and hence with minimal power consumption. In other words, buoyancy system 210 will cause robot 200 to sink through the downhole fluid 125 in vertical segment 110. Sensors and control equipment will generally remain operational. However, their power consumption will generally be a small fraction of the power that would be consumed were propulsion system 215 operational during descent. As mentioned above, in some implementations, robot 200 can include a releasable external weight to weigh it down and speed descent. In the event that the robot 200 is sufficiently neutrally buoyant (e.g., having a density that is within 20% of the wellbore fluid in which it is operating), buoyancy system 210 can be omitted and robot 200 can exclusively use its propulsion system 215 for the vertical traversal.

FIG. 8 illustrates the downward navigation of robot 200 as it approaches deviated section 120. Sensors, such as vibrating components 230, can use echolocation or other techniques to sense geometric and possibly other structural information regarding the walls and other features of the wellbore and the approach of deviated section 120. The structural information can be provided to the on-board controller. In response, the controller can instruct buoyancy system 210 to change the longitudinal distribution of weight in robot 200. For example, the bow (front) of robot 200 can be made less dense, the stern (rear) of robot 200 can be made more dense, or the densities of both the bow and the stern can be changed. In any case, the changes can result in the bow of robot 200 descending slower than the stern. As a result, robot 200 will begin to reorient, leaving a vertical or nearly vertical orientation and shifting to a more lateral orientation. In the event that the robot 200 is sufficiently neutrally buoyant (e.g., having a density that is within 20% of the wellbore fluid in which it is operating), buoyancy system 210 can be omitted and robot 200 can exclusively use its propulsion system 215 for traversal. Robot 200 passively reorients as it traverses the wellbore.

In some implementations, the lateral direction of the reorientation (for example, to the left or right in the plane of the page, or into and out of the plane of the page) does not require that a separate steering mechanism be included in robot 200. Rather, the bow of robot 200 is guided via contact with a sidewall of the wellbore during descent. A longitudinal distribution of weight in robot 200 may change after robot 200 is reoriented by the sidewall.

In other implementations, the lateral direction of the reorientation is regulated by the controller using any of a variety of different steering mechanisms. For example, rudders, hydroplanes, drag-generating components, steerable propellers, radial or other lateral redistributions of weight, or the like can be used to control the lateral direction of reorientation. In some cases, information regarding the orientation/inclination of robot can be received from a gyroscopic orientation sensor 230 or the like can be used in the regulation.

In some implementations, measurements of the local density of downhole fluid 125 provided to the controller. The information regarding the local density can be used to tune the control of buoyancy system 210. In particular, even minor variations in the density of downhole fluid 125 can be considered when controlling the longitudinal and/or radial or other lateral distribution of weight in robot 200.

Also, in implementations where buoyancy systems 210 includes and external releasable weight, the controller can trigger release of the weight as robot 200 approaches deviated section 120.

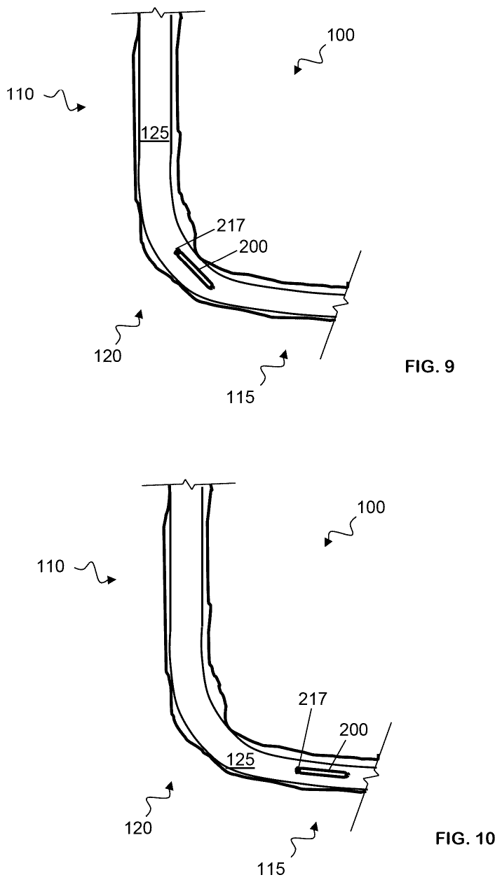

FIG. 9 illustrates a combined downward and horizontal navigation of robot 200 in deviated section 120. The controller may regulate the orientation of robot 200 by controlling the longitudinal distribution of weight in robot 200 using buoyancy system 210. In particular, the controller seeks to match the orientation/inclination of robot 200 to the structure of deviated section 120 relying upon structural information regarding wellbore 100 and information regarding fluid downhole 125 surrounding robot 200, as well as speed and orientation/inclination information regarding robot 200. In the event that the robot 200 is sufficiently neutrally buoyant (e.g., having a density that is within 20% of the wellbore fluid in which it is operating), buoyancy system 210 can be omitted and t robot 200 can exclusively use its propulsion system 215 for traversal. Robot 200 can passively reorient as it traverses the wellbore.

In some implementations, the controller uses buoyancy system 210 in conjunction with lower-power steering mechanisms such as rudders, hydroplanes, drag-generating components to regulate the orientation of robot 200. In these implementations, the power consumption will generally be lower than in implementations where a higher-power, thrust-generating propulsion system 215 is also used to regulate the orientation of robot 200. However, even if both buoyancy system 210 and propulsion system 215 are used to regulate the orientation, the total power consumption will generally be lower than were propulsion system 215 used alone.

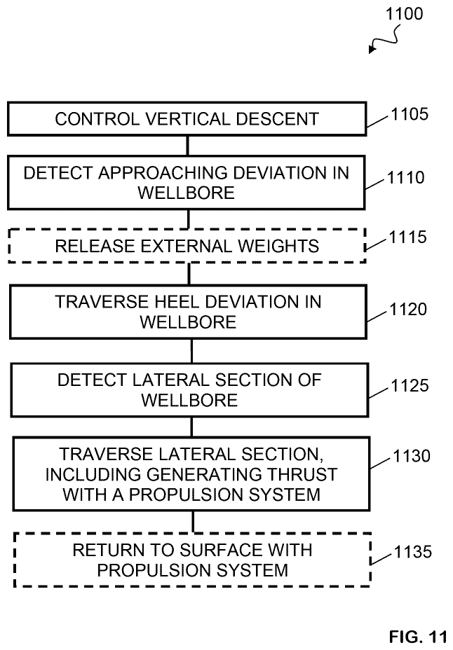

FIG. 10 illustrates nearly horizontal navigation of robot 200 as it leaves deviated section 120 and enters lateral section 115. The controller has regulated the orientation of robot 200 such that robot 200 is in a nearly horizontal profile that matches the structure of lateral section 115.

The thrust for lateral navigation is generally provided exclusively by propulsion system 215, resulting in a relatively higher power consumption than exclusive buoyancy changes in the vertical traversal. However, because the higher power consumption by propulsion system 210 has been delayed, more power remains available from power source 220 for extended range (e.g., for a range of beyond 50,000 feet or 15 km of traversal. A sufficiently neutrally buoyant robot 200 may be capable of traversing the entirety of a wellbore under its own power.

In some cases, buoyancy system 210 may remain in operation during lateral navigation. In particular, the controller can use the buoyancy system 210 to maintain robot 200 nearly neutrally buoyant (e.g., within + or −20%) in the lateral section—notwithstanding any changes in the density of the surrounding wellbore fluid. In the event that the robot 200 is sufficiently neutrally buoyant (e.g., having a density that is within 20% of the wellbore fluid in which it is operating), buoyancy system 210 can be omitted. In some implementations, buoyancy system 210 can also be used to control the orientation of robot 200 and movement of robot 200 upward and downward within the relatively narrower confines of lateral section 115. In either case, control can be implemented using structural information regarding wellbore 100 and information regarding fluid downhole 125 surrounding robot 200, as well as speed and orientation/inclination information regarding robot 200.

FIG. 11 is a flowchart of a process 1100 for navigating a robot in a wellbore. The operations in process 1100 can be performed by a controller in accordance with the logic of machine-readable instructions. The instructions can be embodied in software, in firmware, in hardware, or in combinations thereof. In some implementations, the controller that performs process 1100 also performs other operations at the same time, during the navigation. For example, the same controller may collect logging or other information, communicate with external equipment, or the like. In some implementations, process 1100 can be performed by controller 225 in robot 200, using buoyancy system 210, propulsion system 215, and other components described above.

In general, the robot that is navigating the wellbore will perform additional operations during navigation. For example, the robot will generally measure downhole properties that are relevant to characterizing the wellbore as it moves through the wellbore. Thus, properties that are relevant to navigating the wellbore and properties that are relevant to characterizing the wellbore can be measured at the same time.

At 1105, the controller controls vertical descent of the robot. In controlling the vertical descent, the controller controls a buoyancy system to ensure that the density of the robot is higher than the surrounding downhole fluid. For example, ballast tanks/chambers can be filled with relatively dense liquids. External, releasable weights can be retained by the robot. In the event that the robot 200 is sufficiently neutrally buoyant (e.g., having a density that is within 20% of the wellbore fluid in which it is operating), the buoyancy system can be omitted and the robot may be propelled exclusively by propulsion system 215.

In some implementations, the controller may use one or more steering components (e.g., rudders, hydroplanes, drag-generating components) to regulate the orientation of the robot during descent and/or ensure that the robot is appropriately positioned within the wellbore to, e.g., minimize contact with the sidewalls or other obstructions. The information used in such regulation can be gathered by echolocation or other techniques that sense the structure of the sidewalls or obstructions. In some cases, information regarding the orientation/inclination of robot can be received from a gyroscopic orientation sensor 230 or the like can be used in the regulation.

In some implementations, the controller can also control a thrust-generating propulsion system to control the vertical descent of the robot. For example, a propulsion system may be used to steer the robot and/or speed the descent, albeit at the cost of higher power consumption.

At 1110, the controller detects that the robot is approaching a deviation from vertical in the wellbore. The approaching deviation can be detected by inclination angle measurement, depth measurement, echolocation or other techniques.

At 1115, if present, the controller can release external weights of a buoyancy system that have been used to drive the descent. In general, the released weights will not be recovered and will remain downhole. The released weight may be a dissolvable material or a liquid.

At 1120, the robot traverses the deviation in the wellbore. In some implementation, the robot exclusively uses its propulsion system (if near neutrally buoyant) and passively reorients due to contact with the internal walls of the wellbore. Alternatively, the robot navigates by controlling at least the longitudinal distribution of weight in the robot if a buoyancy system is being used. In particular, the controller controls a buoyancy system to reorient the robot so that it leaves a vertical or nearly vertical orientation and shifts to a more lateral orientation that follows the structure of the deviation. The controller can control the buoyancy system to make the bow of the robot less dense and/or the stern more dense.

In some cases, the controller will use one or more steering components (e.g., rudders, hydroplanes, drag-generating components, lateral distribution of weight in the robot) to regulate the orientation of the robot during descent and/or ensure that the robot is appropriately positioned within the deviated portion of the wellbore, e.g., to avoid contact with the sidewalls or other obstructions. The information used in such regulation can be gathered by echolocation or other techniques that sense the structure of the sidewalls or obstructions. In some cases, information regarding the orientation/inclination of robot can be received from a gyroscopic orientation sensor 230 or the like can be used in the regulation.

At 1125, the controller detects that the robot is approaching a lateral section of the wellbore. The approaching lateral section can be detected by inclination angle measurement, depth measurement, echolocation or other techniques.

At 1130, the controller navigates the robot through the lateral section of the wellbore by controlling a thrust-generating propulsion system. The controller may use one or more steering components to ensure that the robot is appropriately positioned within the lateral section of the wellbore, e.g., to minimize contact with the sidewalls or other obstructions. The information used in such regulation can be gathered by echolocation or other techniques that sense the structure of the sidewalls or obstructions, as well other sensors that sense the orientation/inclination of the robot. In some implementations, a housing of the robot includes protruding fins or other members configured to reduce the contact area with the adjacent walls, resulting in passive centralization of the robot. For example, three or more non-actuated fins may be distributed around the housing, equidistantly or otherwise, and passively centralize the robot within the wellbore by preventing the entire hull of the robot from contacting the wellbore wall.

In some implementations, the controller will also use a buoyancy system during lateral navigation to maintain the robot nearly neutrally buoyant (e.g., within + or −20%) in the lateral section and/or to control the horizontal orientation of the robot and move the robot upward and downward within the relatively narrower confines of the lateral section. The control can be implemented using structural information regarding the wellbore and information regarding fluid downhole surrounding robot, as well as speed and orientation/inclination information regarding robot.

In some implementations, the controller can navigate the robot through the entirety of the lateral section, i.e., to the “toe” at the end of the lateral section.

In some implementations, the controller can operate one or more reversible attachment mechanisms to fix the robot to the borehole or casing of the wellbore. Reversible attachment of the robot to the wellbore can stabilize the measurement of downhole properties that are relevant to characterizing the wellbore. Example attachment mechanisms include retractable centralizers, electromagnets, and the like. In some instances, the controller can operate the attachment mechanisms to fix the robot several times during navigation in the wellbore at different locations. For example, the controller can fix the robot in a vertical segment, in a lateral (or horizontal) section, and/or in a heel or other deviated section.

At 1135, if desired, the robot returns to the surface using the propulsion system. The robot may also use a buoyancy system to become more positively buoyant to assist its ascent in the vertical section of the wellbore. The direction of the thrust that is generated by a propulsion system can be reversed in the lateral, deviated, and vertical sections of the wellbore. In wells in which fluid flows to the surface (e.g., a producing well), the propulsion system can simply stop generating thrust that opposes the direction of fluid flow and the wellbore fluids can flow the robot back to the surface. The robot may navigate and traverse vertical sections of the wellbore by controlling a buoyancy system to make the robot more positively buoyant, e.g., by releasing additional external weights, pushing liquid out of chambers/ballast tanks that communicate with the surroundings, or the like. Thus, the buoyancy system may be bidirectional and can make the robot more or less buoyant than the surrounding downhole fluid. The robot can be retrieved upon reaching the surface.

As discussed above, robots can measure downhole properties that are relevant to characterizing the wellbore. Examples of such downhole properties include, but are not limited to, pressure, temperature, volume fractions of oil, brine, or gas, levels/locations of/depths to the dew point for gas condensate, liquid condensate, oil, or brine along the well, flow rate of oil, brine, or gas phases, inflow rate of the oil, brine, or gas into the well from surrounding rock formations, the density or viscosity of drilling mud and the depth of invasion of the drilling mud into surrounding rock formations, the thickness or consistency, or degree of coverage of mudcake that may remain on the borehole wall, the chemical composition of the water or brine mixture, the chemical composition of the hydrocarbons, the physical properties of the downhole fluids, including, for example, density or viscosity, the multiphase flow regime, the optical properties of the hydrocarbons or brine such as turbidity, absorption, refractive index, or fluorescence, fluorescing tracers, the amount of or type of corrosion or scale on the casing or production tubing, the rate of corrosion or scale growth, the presence or absence or concentration of corrosion inhibitor or scale inhibitor chemicals that might be added to the well, the open cross-section within the production tubing or borehole which would conventionally be measured by calipers, the acoustical or elastic properties of the surrounding rock, which may be isotropic or anisotropic, the electrical properties of the surrounding rock, including, for example, the surrounding rock's resistive or dielectric properties, which may be isotropic or anisotropic, the density of the surrounding rock, the presence or absence of fractures in the surrounding rock and the abundance, orientation, and aperture of these fractures, the total porosity or types of porosity in the surrounding rock and the abundance of each pore type, the mineral composition of the surrounding rock, the size of grains or distribution of grain sizes and shapes in the surrounding rock, the size of pores or distribution of pore sizes and shapes in the surrounding rock, the absolute permeability of the surrounding rock, the relative permeability of the surrounding rock, the wetting properties of fluids in the surrounding rock, contact angles of the fluids on a surface, and the surface tension of fluid interfaces along the well or in the surrounding rock.

A number of implementations have been described. Nevertheless, it will be understood that various modifications may be made. Accordingly, other implementations are within the scope of the following claims.

What is claimed is:

1. An untethered, downhole robot is configured to have a density within + or −20% of wellbore fluid in which it will be operating, the downhole robot comprising:
a generally elongate housing;
at least one propulsion unit on an end of the housing on the longitudinal axis;
a sensor system configured to sense structural information regarding geometry of a wellbore, determine position and orientation of the robot in the wellbore, and collect measurements characterizing the wellbore fluids and reservoir characteristics;
a controller coupled to receive the sensed structural information and wellbore fluid information to control the robot's traversal within the wellbore; and
a memory device to log collected data locally on robot.

2. The downhole robot of claim 1, further comprising:
a buoyancy system configured to change the longitudinal distribution of weight of the robot is present to aid with vertical descent and ascent when the robot is not sufficiently neutrally buoyant; and
a controller capable of discerning deviation of the wellbore from vertical and, in response, control the buoyancy system to change longitudinal distribution of the weight of the robot, wherein the magnitude of the change in the longitudinal distribution of the weight suffices to reorient the robot.

3. The downhole robot of claim 2, wherein, in response to discernment of the deviation during descent of the robot into the wellbore, the controller is configured to control the buoyancy system to change the longitudinal distribution of the weight of the robot such that a bow of the robot is made less dense, a stern of the robot is made more dense, or densities of both the bow and the stern are changed.

4. The downhole robot of claim 2, wherein the controller is configured to regulate a lateral direction of the reorientation of the robot that occurs responsive to the changed longitudinal distribution of weight.

5. The downhole robot of claim 4, wherein the robot further comprises a steering mechanism coupled to the controller, wherein the controller is configured to regulate the lateral direction of the reorientation of the robot using the steering mechanism.

6. The downhole robot of claim 4, wherein:
the downhole robot further includes an orientation sensor configured to sense an orientation of the robot; and
the controller coupled to receive the sensed orientation information from the orientation sensor and to regulate the lateral direction of the reorientation based thereon.

7. The downhole robot of claim 2, wherein:
the downhole robot comprises a density sensor configured to sense density of a downhole fluid surrounding the downhole robot; and
the controller is further configured to control the buoyancy system to change the longitudinal distribution of the weight of the robot based on the sensed density of the downhole fluid.

8. The downhole robot of claim 2, wherein the buoyancy system is a multi-chamber, internal buoyancy system that conveys liquid between chambers without communicating fluid with surroundings of the downhole robot.

9. The downhole robot of claim 2, wherein the buoyancy system is configured to communicate fluid with surroundings of the downhole robot.

10. The downhole robot of claim 2, wherein:
the buoyancy system is configured to change lateral distribution of weight of the robot; and
the controller is configured to control the changes in the lateral distribution of the weight based on the sensed structural information.

11. The downhole robot of claim 1, further comprising three or more protruding members distributed around the housing, wherein the protruding members are configured to contact an inner wall of a wellbore that is being traversed while preventing the housing from contacting the inner wall.

12. A method of navigating a wellbore with a downhole robot, the method performed by a controller of the downhole robot and comprising:
detecting, using a sensor located on the downhole robot, approach of the downhole robot to a deviation of the wellbore from vertical; and
in response to the detection of the approach of the deviation, changing longitudinal distribution of weight of the downhole robot, wherein the change in the longitudinal distribution of the weight suffices reorient the downhole robot.

13. The method of claim 11, wherein changing the longitudinal distribution of weight of the downhole robot comprises causing a bow of the downhole robot to descend slower than a stern of the downhole robot.

14. The method of claim 11, further comprising controlling a direction of the lateral reorientation of the downhole robot.

15. The method of claim 13, wherein controlling the direction of the lateral reorientation of the downhole robot comprises controlling
a rudder, or
a hydroplane, or
a drag-generating components, or
a steerable propeller, or
a lateral redistribution of weight of the downhole robot.

16. The method of claim 14, wherein controlling the direction of the lateral reorientation of the downhole robot comprises sensing an orientation of the downhole robot and using the sensed orientation to control the direction of the lateral reorientation of the downhole robot.

17. The method of claim 14, wherein changing the longitudinal distribution of weight of the downhole robot comprises moving a fluid bow-ward or stern-ward between chambers housed in the robot.

18. The method of claim 14, wherein changing the longitudinal distribution of weight of the downhole robot comprises communicating a fluid with a surroundings of the downhole robot.

19. The method of claim 14, further comprising guiding the downhole robot into a sidewall of the wellbore prior to changing the longitudinal distribution of the weight of the downhole robot.

20. The method of claim 14, further comprising guiding the downhole robot into a sidewall of the wellbore prior to changing the longitudinal distribution of the weight of the downhole robot.

21. The method of claim 14, further comprising:
detecting, using the sensor, approach of the downhole robot to a lateral section of the wellbore; and
in response to the detection of the approach of the lateral section, generating thrust to propel the downhole robot.

22. The method of claim 14, wherein:
the method further comprises sensing a density of downhole fluid surrounding the downhole robot; and
the longitudinal distribution of weight of the downhole robot is changed based on the sensed density.

23. A method of navigating a wellbore with an untethered autonomous downhole robot that has a density within + or −20% of wellbore fluid in which it will be operating, the method performed by a controller of the downhole robot and comprising:
detecting, using a sensor located on the downhole robot, approach of the downhole robot to a deviation of the wellbore from vertical; and
in response to the detection of the approach of the deviation, exclusively driving the robot with a propulsion unit, the driving including traversing a portion of the wellbore and passively reorienting the robot via guidance from geometry of the wellbore.

24. The method of claim 23, wherein the robot comprises:
sensors configured to measure wellbore geometry, wellbore fluid information, reservoir characteristics; and
sensors configured to measure speed of the robot, depth of the robot, angular rate of the robot, attitude of the robot, and/or acceleration of the robot.

25. The method of claim 23, further comprising:
determining, by the controller of the downhole robot, position of the robot within the wellbore; and
determining, by the controller of the downhole robot, orientation of the robot within the wellbore.

26. The method of claim 23, further comprising:
operating a stern-mounted thruster and a bow-mounted thruster to generate thrust in both a forward direction and in a reverse direction.

27. The method of claim 26, further comprising:
operating the stern-mounted thruster and the bow-mounted thruster at different speeds to roll the robot.

28. The method of claim 23, wherein the downhole robot further comprises three or more protruding members distributed around the housing, wherein passively reorienting the downhole robot comprises contacting an inner wall of a wellbore with at least one of the protruding members while preventing the housing from contacting the inner wall.

29. The method of claim 23 further comprising:
adjusting, by the controller of the downhole robot, an orientation of the robot using the propulsion unit.
